(19) United States
(12) Patent Application Publication
(10) Pub. No.: US 2025/0376122 A1
(43) Pub. Date: Dec. 11, 2025

(54) COVER MEMBER

(71) Applicant: TOYOTA BOSHOKU KABUSHIKI KAISHA, Aichi-ken (JP)

(72) Inventors: Hiroshi TSUJI, Nagoya-shi (JP); Fumitoshi AKAIKE, Miyoshi-shi (JP)

(73) Assignee: TOYOTA BOSHOKU KABUSHIKI KAISHA, Aichi-ken (JP)

(21) Appl. No.: 19/225,311

(22) Filed: Jun. 2, 2025

(30) Foreign Application Priority Data
Jun. 5, 2024 (JP) 2024-091311

(51) Int. Cl. B60R 13/02

(52) U.S. Cl. CPC B60R 13/02

(57) ABSTRACT

A cover member includes a base material including a first base material and a second base material, and a surface material covering a surface of the base material. The first base material has a first erected edge erected to a back side of the first base material along a base material peripheral edge, and the second base material has a second erected edge erected to a back side of the second base material to face the first erected edge, the second base material being bonded to overlap the back side of the first base material. The surface material includes a cover covering a surface of the first base material, and a surface end pressed and clamped between the first erected edge and the second erected edge, the surface end being caught from the base material back side to overlap an inner surface of the first erected edge.

### CROSS-REFERENCE TO RELATED APPLICATIONS

This application is based on and claims priority under 35 USC 119 from Japanese Patent Application No. 2024-091311 filed on Jun. 5, 2024, the entire content of which is incorporated herein by reference.

### TECHNICAL FIELD

The present disclosure relates to a cover member. Specifically, the present disclosure relates to a cover member including a base material extending in a planar shape and a surface material covering a surface of the base material.

### BACKGROUND ART

JP6440460B discloses a cover member constituting an interior trim of an automobile. The cover member includes a resin base material and a surface material covering a surface of the base material. In the surface material, a surface end on a peripheral edge that covers the base material is caught on a back surface of the base material and fixed by an adhesive.

In the configuration described in JP6440460B, the surface end may peel off from the back surface of the base material when adhesion by the adhesive is not sufficient. Therefore, the present disclosure provides a cover member in which a surface end of a surface material can be appropriately fixed to a base material.

To solve the above problem, the cover member of the present disclosure has following configurations.

### SUMMARY OF INVENTION

According to a first aspect of the disclosure, a cover member includes a base material extending in a planar shape and including a first base material and a second base material, and a surface material covering a surface of the base material. The base material includes a planar first base material having the first base material has a first erected edge erected to a base material back side of the first base material along a base material peripheral edge, and a second base material having the second base material has a second erected edge erected to the base material a back side of the second base material to face the first erected edge, the second base material being bonded to overlap the base material back side of the first base material. The surface material includes a cover covering a surface of the first base material, and a surface end pressed and clamped between the first erected edge and the second erected edge, the surface end being caught from the base material back side to overlap an inner surface of the first erected edge.

According to the first aspect, the surface end of the surface material covering the surface of the base material is fixed in a state of being caught between the first erected edge of the first base material and the second erected edge of the second base material. In this way, the surface end can be appropriately fixed to the base material by being pressed and clamped between the erected edges (between the first erected edge and the second erected edge) of the first base material and the second base material bonded to each other.

According to a second aspect of the disclosure, the cover member according to first aspect, further includes a double-sided tape that bonds facing surfaces of the first erected edge and the second erected edge to each other. A gap for catching the surface end is defined between the first erected edge and the second erected edge due to a thickness of the double-sided tape.

According to the second aspect of the disclosure, a gap defined by the thickness of the double-sided tape that bonds the facing surfaces of the first erected edge and the second erected edge to each other can appropriately ensure the gap for catching the surface end between the first erected edge and the second erected edge.

According to a third aspect of the disclosure, the cover member according to first or second aspect, further includes a planar pad member interposed in a stacked manner between the surface of the first base material and the cover. The surface end is pressed and clamped between the first erected edge and the second erected edge against an elastic force from the pad member to the cover toward a base material front side.

According to the third aspect, providing the pad member between the base material and the surface material can improve a cushioning property of the cover member. Further, even the surface material receives an elastic force by providing the pad member, the surface material can be appropriately stretched over the base material by appropriately fixing the surface end.

According to a fourth aspect of the disclosure, the cover member according to claim first or second aspect, in which the first base material has a first corner protruding such that the first erected edge is squared along a base material peripheral edge, and the second base material has a second recess recessed to define a space between the second base material and the first corner, the space allowing bending of the surface end due to being caught in an interior angle region of the first corner.

According to the fourth aspect, accumulated wrinkles and seams that may be formed by the surface end being caught in the internal angle region of the first corner can be prevented from being hooked between the first erected edge and the second erected edge. As a result, the surface end can be appropriately fixed to the base material.

According to a fifth aspect of the disclosure, the cover member according to first or second aspect, in which the surface material has a laminated structure in which slab urethane is laminated along back surfaces of the cover and the surface end.

According to the fifth aspect, the slab urethane can provide surface softness to the surface material. In addition, the surface end can have a thickness for being appropriately pressed and clamped between the first erected edge and the second erected edge.

According to a sixth aspect of the disclosure, the cover member according to first or second aspect, in which the second base material has a barb that hooks and fixes a hook hole formed in the surface end.

According to the sixth aspect, the surface end can be more appropriately fixed between the first erected edge and the second erected edge.

According to a seventh aspect of the disclosure, the cover member according to first or second aspect, in which the surface end is bonded to an intermediate portion of the first base material which is separated from the first erected edge to be obliquely bridged between an erected top edge side of the first erected edge and a back surface of the intermediate portion, and, when the second base material overlaps the first base material, the surface end is pressed by the second base material and stretched between the edge side of the first erected edge and the intermediate portion.

According to the seventh aspect, the surface end can be fixed in a state of being appropriately drawn between the first erected edge and the second erected edge.

### BRIEF DESCRIPTION OF DRAWINGS

FIG. 1 is a perspective view of a seat to which a cover member according to a first embodiment is applied;

FIG. 2 is a side view of the cover member;

FIG. 3 is a perspective view of the cover member as viewed from a cover back side;

FIG. 4 is an exploded perspective view of the cover member;

FIG. 5 is the exploded perspective view of FIG. 4 as viewed from the cover back side;

FIG. 6 is a perspective view illustrating a state in which a second base material is assembled to a first base material;

FIG. 7 is a cross-sectional view taken along a line VII-VII in FIG. 2;

FIG. 8 is a schematic view illustrating a configuration of a cover member according to another embodiment; and

FIG. 9 is a schematic view illustrating a configuration of a cover member according to another embodiment.

### DESCRIPTION OF EMBODIMENTS

Hereinafter, embodiments of the present disclosure will be described with reference to the drawings.

### First Embodiment

### <Schematic Configurations of Cover Member>

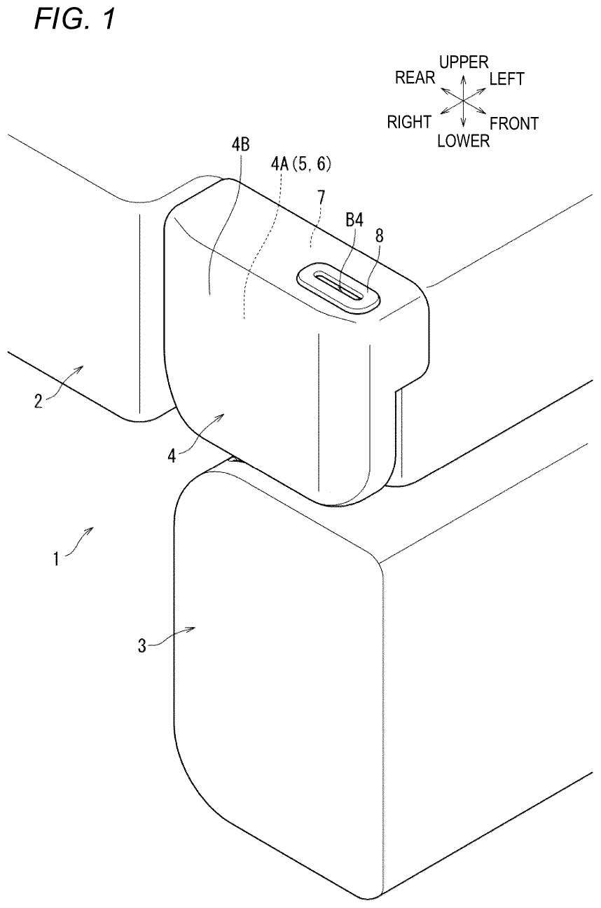

First, configurations of a cover member (side shield 4) according to a first embodiment of the present disclosure will be described with reference to FIGS. 1 to 7. In the following description, when a direction such as front, rear, upper, lower, left, and right is referred to, the direction indicates a corresponding direction illustrated in the drawings.

When a direction is referred to with “seat” attached thereto such as “seat width direction”, the direction indicates a corresponding direction relative to a seat 1. In the following description, when no specific reference drawing is referred to or there is no corresponding reference numeral in the reference drawing, any one of FIGS. 1 to 7 is referred to as appropriate.

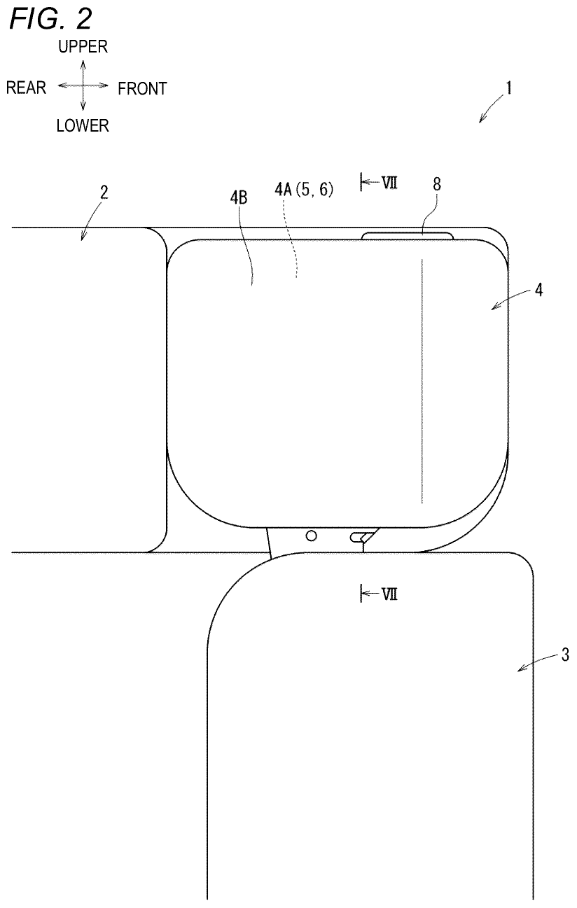

As illustrated in FIGS. 1 and 2, the cover member according to the present embodiment is implemented by the side shield 4 that covers a coupling portion of an ottoman 3 of the seat 1 of an automobile from both left and right sides. The ottoman 3 is coupled to a front edge of a seat cushion 2 to be unfolded and folded by rotation.

Each side shield 4 covers a coupling portion between the ottoman 3 and the seat cushion 2 in a planar shape from both sides in a seat width direction. Each side shield 4 is fixed to a frame (not illustrated) of the seat cushion 2.

An operation strap for unlocking a lock device (not illustrated) for fixing the ottoman 3 in a fixed position is drawn from the right side shield 4. Each side shield 4 has the same basic structure with each other. Therefore, hereinafter, configurations of the right side shield 4 illustrated in the drawing will be described in detail as a representative.

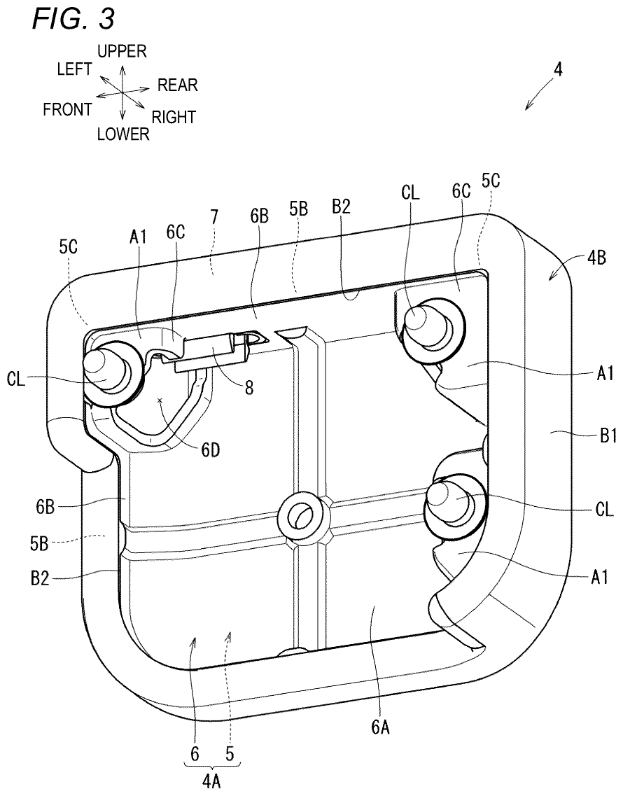

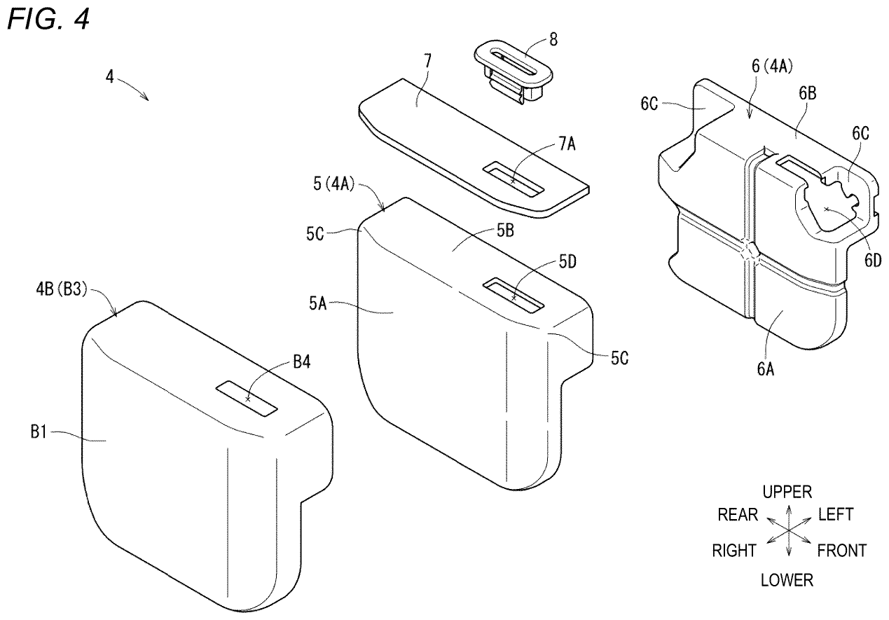

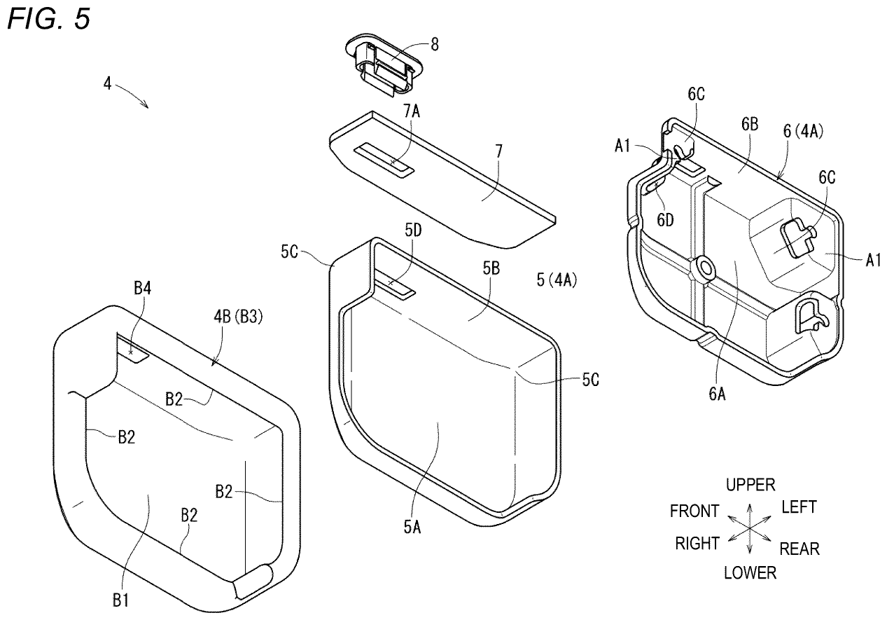

As illustrated in FIG. 3, the side shield 4 includes a resin base material 4A having a rectangular plate shape and a fabric surface material 4B covering a surface of the base material 4A. More specifically, as illustrated in FIGS. 4 and 5, the base material 4A includes a first base material 5 constituting an outer shield and a second base material 6 constituting an inner shield, and has a double inner and outer shield structure obtained by overlapping the first base material 5 and the second base material 6 into one.

As illustrated in FIG. 5, the first base material 5 is a member that defines a design shape of the side shield 4. The second base material 6 is a fixing member including fastening seats A1 (see FIG. 3) on which clips CL (see FIG. 3) for fixing the side shield 4 to the frame of the seat cushion 2 (see FIGS. 1 and 2) are installed.

The first base material 5 includes a base material body 5A extending in a rectangular plate shape and a first erected edge 5B erected to a left side (base material back side) along a peripheral edge of the base material body 5A. The first erected edge 5B extends endlessly over the entire peripheral edge of the base material body 5A. Specifically, the first erected edge 5B has a shape in which a part erected from an upper edge, a rear edge, and an upper region of a front edge of the base material body 5A is erected more to the left side than the other erected part.

The second base material 6 includes a base material body 6A extending in a rectangular plate shape and a second erected edge 6B erected to the left side (base material back side) along a peripheral edge of the base material body 6A. The base material body 6A has a rectangular plate shape slightly smaller than the base material body 5A of the first base material 5. The second erected edge 6B extends endlessly over the entire peripheral edge of the base material body 6A.

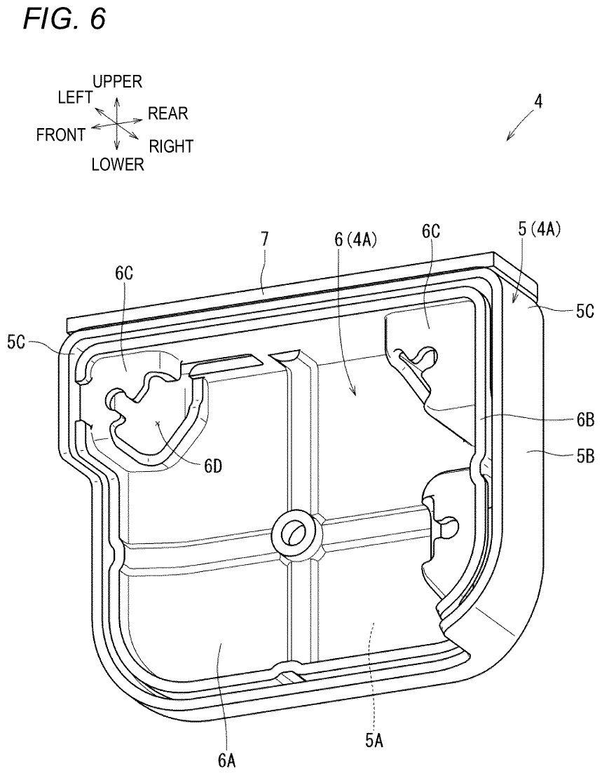

Specifically, similarly to the first erected edge 5B of the first base material 5, the second erected edge 6B has a shape in which a part erected from an upper edge, a rear edge, and an upper region of a front edge of the base material body 6A is erected more to the left side than the other erected part. As illustrated in FIG. 6, the second base material 6 is assembled such that the base material bodies 6A and 5A overlap each other on the left side (base material back side) of the first base material 5.

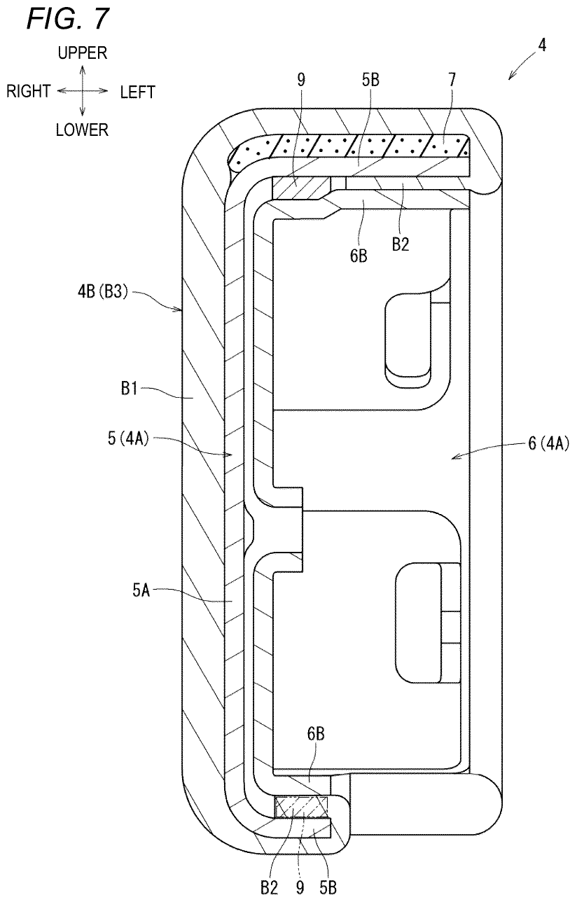

Accordingly, the second base material 6 is set such that the second erected edge 6B faces the first erected edge 5B of the first base material 5 over an entire periphery. As illustrated in FIG. 7, the first base material 5 and the second base material 6 are bonded to each other by a plurality of double-sided tapes 9 set between facing surfaces of the first erected edge 5B and the second erected edge 6B.

By this bonding, the first base material 5 and the second base material 6 are fixed in a state in which a gap having a substantially constant width corresponding to a thickness of the double-sided tape 9 is defined between the first erected edge 5B and the second erected edge 6B over the entire periphery. The double-sided tape 9 extends along a peripheral direction between the first erected edge 5B and the second erected edge 6B to bond portions close to base ends of the first erected edge 5B and the second erected edge 6B.

Specifically, the two facing surfaces can be bonded by bonding one surface of the double-sided tape 9 to either the first erected edge 5B or the second erected edge 6B in advance, overlapping the first base material 5 and the second base material 6, and then peeling off a release liner attached to the other surface of the double-sided tape 9.

As illustrated in FIG. 5, four corners of the first base material 5 have a shape in which the first erected edge 5B protrudes to be squared along a base material peripheral edge. Similarly, the second base material 6 has a shape in which four corners of the second base material 6 have a shape in which the second erected edge 6B protrudes to be squared along a base material peripheral edge.

The second base material 6 is formed with, at each of an upper front corner and an upper rear corner thereof, a second recess 6C recessed to the left side (base material back side) to widen a gap between the corresponding corner and a first corner 5C on each of an upper front side and an upper rear side of the first base material 5. The second recess 6C on a front side is further formed with an opening 6D running in a height direction. The opening 6D is further formed across the second erected edge 6B constituting an upper erected edge of the second base material 6.

The opening 6D serves as a hole communicating in the height direction with a through hole 5D formed in the first erected edge 5B constituting an upper erected edge of the first base material 5. The above-described operation strap (not illustrated) passes through the through hole 5D and the opening 6D and is drawn out in the height direction.

A through hole B4 communicating with the through hole 5D is further formed in the surface material 4B covering the surface of the base material 4A. The side shield 4 further includes a pad member 7 made of a rectangular plate-shaped foamed urethane and provided on an upper surface of the first erected edge 5B constituting the upper edge of the first base material 5. The pad member 7 is interposed in a stacked manner between the upper surface of the first erected edge 5B on an upper side and the surface material 4B covering a surface of the pad member 7 (see FIG. 7).

As illustrated in FIG. 5, the pad member 7 is further formed with a through hole 7A communicating with the through hole 5D. Providing the pad member 7 between the base material 4A and the surface material 4B as described above improves a cushioning property of a top plate part of the side shield 4.

The side shield 4 further includes a tubular bezel 8 installed to cover an inner peripheral surface of the through hole B4 formed in the surface material 4B. The bezel 8 passes through and is fixed to the through hole B4 of the surface material 4B, the through hole 7A of the pad member 7, the through hole 5D of the first base material 5, and the opening 6D of the second base material 6. The bezel 8 functions as a guide through which the above-described operation strap (not illustrated) passes.

The surface material 4B includes a cover B1 that covers a surface of the first base material 5, and surface ends B2 that are caught on and fixed to the base material back side of the first base material 5. The surface material 4B has a laminated structure in which slab urethane B3 is laminated on an entire back surface of the cover B1 and the surface ends B2. The slab urethane B3 provides surface softness to the surface material 4B, and the surface material 4B is formed in a shape having a thickness allowing large crush in a thickness direction.

As illustrated in FIG. 7, the cover B1 covers an entire surface of the base material body 5A of the first base material 5 and an entire surface of the first erected edge 5B. The surface ends B2 constituting front, rear, upper, and lower peripheral edges of the cover B1 are caught on the first erected edge 5B from the base material back side and overlap inner surfaces of the first erected edge 5B.

When the second base material 6 is assembled to overlap the first base material 5, each surface end B2 is pressed and clamped between a corresponding inner surface of the first erected edge 5B and a corresponding outer surface of the second erected edge 6B. Specifically, each surface end B2 is pressed and clamped between a corresponding inner surface of the first erected edge 5B and a corresponding outer surface of the second erected edge 6B together with the slab urethane B3 laminated on a back surface thereof.

As a result, the surface ends B2 are fixed in a state of being caught between the first erected edge 5B of the first base material 5 and the second erected edge 6B of the second base material 6 (see FIG. 3). As illustrated in FIG. 7, a gap for catching the surface ends B2 between the first erected edge 5B and the second erected edge 6B is appropriately ensured by the gap defined by the thickness of the double-sided tape 9 that bonds the facing surfaces of the first erected edge 5B and the second erected edge 6B.

For this reason, a substantially uniform force can be applied to the surface ends B2 between the first erected edge 5B and the second erected edge 6B, and the surface ends B2 can be pressed and clamped substantially uniformly over the entire periphery. The double-sided tape 9 is disposed in a region where no surface end B2 is caught. Accordingly, the catching of the surface ends B2 and the bonding of the first erected edge 5B and the second erected edge 6B by the double-sided tape 9 can be both achieved.

As illustrated in FIG. 3, of the surface ends B2, the surface end B2 caught on each of the upper front corner and the upper rear corner where the first corner 5C of the first base material 5 and the second recess 6C of the second base material 6 are formed is caught in a wide space defined by the second recess 6C. Therefore, accumulated wrinkles and seams that may be formed by the surface end B2 being caught in an internal angle region of the first corner 5C can be freely bent in the wide space defined by the second recess 6C.

As a result, even when accumulated wrinkles and seams are formed in the surface end B2, the accumulated wrinkles and seams can be prevented from being entangled or hooked between the first erected edge 5B and the second erected edge 6B. As illustrated in FIG. 7, the upper surface end B2 is caught between the first erected edge 5B and the second erected edge 6B against an elastic force applied from the pad member 7 to the cover B1 toward a base material front side. However, the upper surface end B2 is appropriately fixed against the elastic force of the pad member 7 by a clamping force generated by the upper surface end B2 being directly pressed and clamped between the first erected edge 5B and the second erected edge 6B.

In summary, the side shield 4 according to the present embodiment has following configurations. In the following description, reference numerals assigned in parentheses correspond to configurations described in the embodiment described above.

That is, a cover member (4) includes a base material (4A) extending in a planar shape and a surface material (4B) covering a surface of the base material (4A). The base material (4A) includes a planar first base material (5) having a first erected edge (5B) erected to a base material back side along a base material peripheral edge, and a second base material (6) having a second erected edge (6B) erected to the base material back side to face the first erected edge (5B), the second base material (6) being bonded to overlap a base material back side of the first base material (5). The surface material (4B) includes a cover (B1) covering a surface of the first base material (5), and a surface end (B2) pressed and clamped between the first erected edge (5B) and the second erected edge (6B), the surface end (B2) being caught from the base material back side to overlap an inner surface of the first erected edge (5B).

According to the above configuration, the surface end (B2) of the surface material (4B) covering the surface of the base material (4A) is fixed in a state of being caught between the first erected edge (5B) of the first base material (5) and the second erected edge (6B) of the second base material (6). In this way, the surface end (B2) can be appropriately fixed to the base material (4A) by being pressed and clamped between the erected edges (between the first erected edge (5B) and the second erected edge (6B)) of the first base material (5) and the second base material (6) bonded to each other.

The cover member (4) further includes a double-sided tape (9) that bonds facing surfaces of the first erected edge (5B) and the second erected edge (6B) to each other. A gap for catching the surface end (B2) is defined between the first erected edge (5B) and the second erected edge (6B) due to a thickness of the double-sided tape (9). According to the above configuration, a gap defined by the thickness of the double-sided tape (9) can appropriately ensure the gap for catching the surface end (B2) between the first erected edge (5B) and the second erected edge (6B).

The cover member (4) further includes a planar pad member (7) interposed in a stacked manner between the surface of the first base material (5) and the cover (B1). The surface end (B2) is pressed and clamped between the first erected edge (5B) and the second erected edge (6B) against an elastic force applied from the pad member (7) to the cover (B1) toward a base material front side.

Providing the pad member (7) between the base material (4A) and the surface material (4B) can improve a cushioning property of the cover member (4). Further, even the surface material (4B) receives an elastic force by providing the pad member (7), the surface material (4B) can be appropriately stretched over the base material (4A) by appropriately fixing the surface end (B2).

The first base material (5) has a first corner (5C) protruding such that the first erected edge (5B) is squared along a base material peripheral edge. The second base material (6) has a second recess (6C) recessed to define a space between the second base material (6) and the first corner (5C), the space allowing bending of the surface end (B2) due to being caught in an interior angle region of the first corner (5C).

According to the above configuration, accumulated wrinkles and seams that may be formed by the surface end (B2) being caught in the internal angle region of the first corner (5C) can be prevented from being hooked between the first erected edge (5B) and the second erected edge (6B). As a result, the surface end (B2) can be appropriately fixed to the base material (4A).

The surface material (4B) has a laminated structure in which slab urethane (B3) is laminated along back surfaces of the cover (B1) and the surface end (B2). According to the above configuration, the slab urethane (B3) can provide surface softness to the surface material (4B). In addition, the surface end (B2) can have a thickness for being appropriately pressed and clamped between the first erected edge (5B) and the second erected edge (6B).

### Other Embodiments

Embodiments according to the present disclosure have been described with reference to one embodiment, whereas the present disclosure can be implemented in various forms other than the above embodiment.

1. In addition to a side shield of an ottoman, the cover member of the present disclosure may be another seat shield disposed on a seat peripheral side surface. Specifically, the seat shield may be a resin cover that hides a seat slide rail, a seat frame, a reclining mechanism, and the like from the outside. The cover member may also be an interior trim such as a door trim and a luggage trim.

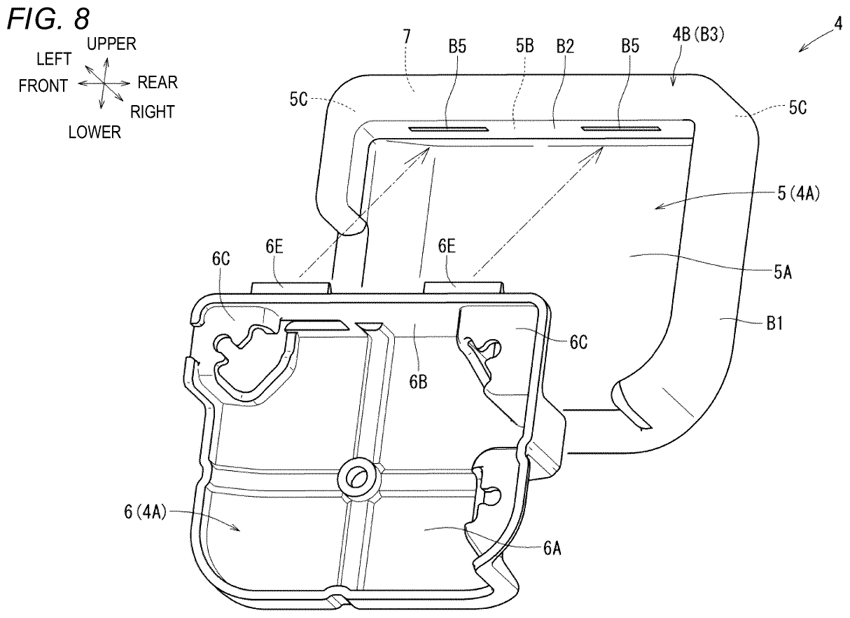

2. As illustrated in FIG. 8, barbs 6E that hook and fix the surface end B2 caught between the second erected edge 6B and the first erected edge 5B may be formed on the second erected edge 6B of the second base material 6. Specifically, the surface end B2 is formed with slit-shaped hook holes B5 for hooking on the barbs 6E, and the surface end B2 is hooked on the barbs 6E.

Accordingly, in addition to being pressed and clamped between the first erected edge 5B and the second erected edge 6B, the surface end B2 can be fixed to the barbs 6E, and can be more appropriately fixed to the base material 4A. Therefore, the surface end B2 can be more appropriately fixed by setting the barbs 6E in positions for fixing the upper surface end B2 that is more likely to receive the elastic force from the pad member 7.

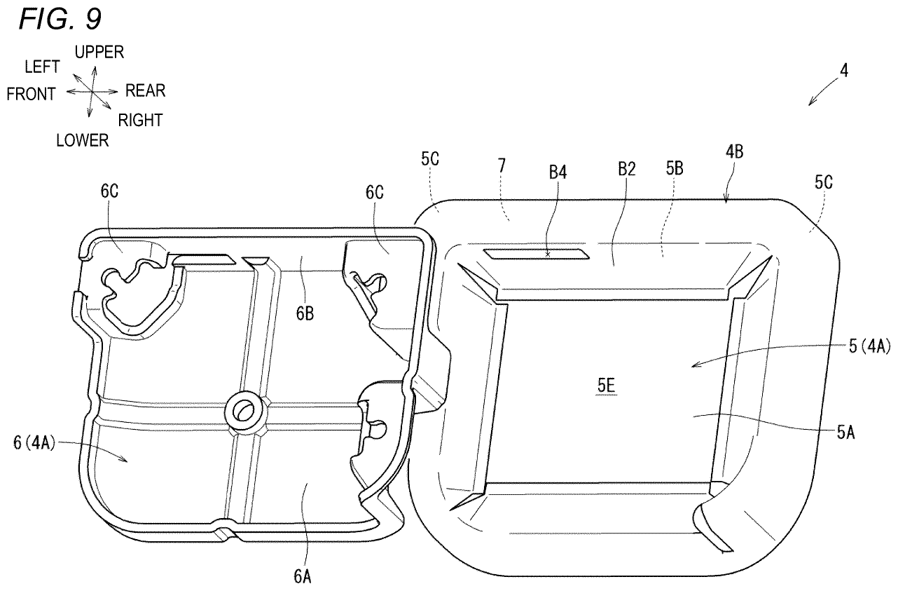

3. As illustrated in FIG. 9, when the surface end B2 is caught between the first erected edge 5B and the second erected edge 6B, the surface end B2 may be first fixed (joined) in a state of being obliquely drawn and bridged from an erected top edge side of the first erected edge 5B of the first base material 5 to a back surface of an intermediate portion 5E of the base material body 5A. In this way, when the second base material 6 is assembled to overlap the first base material 5, the second base material 6 can be pressed against the surface end B2, and the surface end B2 can be stretched between an edge side of the first erected edge 5B and the intermediate portion 5E. As a result, the surface end B2 can be fixed in a state of being appropriately drawn between the first erected edge 5B and the second erected edge 6B.

4. The second recess of the second base material may be a through hole in addition to a recess. The first erected edge formed on the first base material and the second erected edge formed on the second base material are not necessarily formed in an endless shape over entire peripheries thereof. The cover member may have the surface end pressed and clamped between the first erected edge and the second erected edge in at least a part in a peripheral direction.

What is claimed is:

1. A cover member comprising:
a base material extending in a planar shape and including a first base material and a second base material; and
a surface material covering a surface of the base material, wherein the first base material has a first erected edge erected to a back side of the first base material along a base material peripheral edge, and
the second base material has a second erected edge erected to a back side of the second base material to face the first erected edge, the second base material being bonded to overlap the back side of the first base material, and
the surface material includes
a cover covering a surface of the first base material, and
a surface end pressed and clamped between the first erected edge and the second erected edge, the surface end being caught from the base material back side to overlap an inner surface of the first erected edge.

2. The cover member according to claim 1, further comprising:
a double-sided tape that bonds facing surfaces of the first erected edge and the second erected edge to each other, wherein
a gap for catching the surface end is defined between the first erected edge and the second erected edge due to a thickness of the double-sided tape.

3. The cover member according to claim 1, further comprising:
a planar pad member interposed in a stacked manner between the surface of the first base material and the cover, wherein
the surface end is pressed and clamped between the first erected edge and the second erected edge against an elastic force from the pad member to the cover.

4. The cover member according to claim 2, further comprising:
a planar pad member interposed in a stacked manner between the surface of the first base material and the cover, wherein
the surface end is pressed and clamped between the first erected edge and the second erected edge against an elastic force from the pad member to the cover.

5. The cover member according to claim 1, wherein
the first base material has a first corner protruding such that the first erected edge is squared along a base material peripheral edge, and
the second base material has a second recess recessed to define a space between the second base material and the first corner, the space allowing bending of the surface end due to being caught in an interior angle region of the first corner.

6. The cover member according to claim 2, wherein
the first base material has a first corner protruding such that the first erected edge is squared along a base material peripheral edge, and
the second base material has a second recess recessed to define a space between the second base material and the first corner, the space allowing bending of the surface end due to being caught in an interior angle region of the first corner.

7. The cover member according to claim 1, wherein
the surface material has a laminated structure in which slab urethane is laminated along back surfaces of the cover and the surface end.

8. The cover member according to claim 2, wherein
surface material has a laminated structure in which slab urethane is laminated along back surfaces of the cover and the surface end.

9. The cover member according to claim 1, wherein
the second base material has a barb that hooks and fixes a hook hole formed in the surface end.

10. The cover member according to claim 2, wherein
the second base material has a barb that hooks and fixes a hook hole formed in the surface end.

11. The cover member according to claim 1, wherein
the surface end is bonded to an intermediate portion of the first base material which is separated from the first erected edge to be obliquely bridged between an erected top edge side of the first erected edge and a back surface of the intermediate portion, and, when the second base material overlaps the first base material, the surface end is pressed by the second base material and stretched between the edge side of the first erected edge and the intermediate portion.

12. The cover member according to claim 2, wherein
the surface end is bonded to an intermediate portion of the first base material which is separated from the first erected edge to be obliquely bridged between an erected top edge side of the first erected edge and a back surface of the intermediate portion, and, when the second base material overlaps the first base material, the surface end is pressed by the second base material and stretched between the edge side of the first erected edge and the intermediate portion.
